(19) United States
(12) Patent Application Publication
(10) Pub. No.: US 2010/0302466 A1
(43) Pub. Date: Dec. 2, 2010

(54) PROJECTOR AND METHOD FOR CONTROLLING THE SAME

(75) Inventor: Shinji Kubota, Ima-shi (JP)

Correspondence Address: ADVANTEDGE LAW GROUP, LLC, 922 W. BAXTER DRIVE, SUITE 100, SOUTH JORDAN, UT, 84095, US

(73) Assignee: Seiko Epson Corporation, Tokyo (JP)

(21) Appl. No.: 12/790,007

(22) Filed: May 28, 2010

(30) Foreign Application Priority Data
May 29, 2009 (JP) 2009-130086

(51) Int. Cl. H04N 3/26

(52) U.S. Cl. 348/745; 348/E03.048

(57) ABSTRACT

A projector includes: a projection lens including a zoom mechanism; a zoom drive unit that drives the zoom mechanism; a zoom amount storage unit that stores an amount of zooming produced when the zoom drive unit drives the zoom mechanism; an operation signal receiving unit that receives a predetermined operation signal; and a zoom control unit that controls the zoom drive unit so as to change a current zooming state to an initial zooming state when the operation signal receiving unit receives the predetermined operation signal, the initial zooming state is determined by the amount of zooming stored in the zoom amount storage unit.

The entire disclosure of Japanese Patent Application No. 2009-130086 filed May 29, 2009 is expressly incorporated by reference herein.

### BACKGROUND

1. Technical Field

The present invention relates to a projector and a method for controlling the same.

2. Related Art

Some projectors of related art change the angle of projection field of an image (the size of an image) by changing the relative positions of a plurality of lenses that form a projection lens to change the state of zooming. JP-A-11-109214 discloses a projector in which the initial zoom ratio (initial state of zooming) of the projection lens at the time of power-on can be set to a value selected from the highest or lowest zoom ratio (state of zooming) or the zoom ratio at the time of power-off. A zoom drive mechanism in the projection lens is operated in accordance with the initial zoom ratio selected and set when the projector is turned off. In this way, the projection lens, when powered on next time, can have the initial zoom ratio having been selected and set.

In the projector described in JP-A-11-109214, however, when the projector is powered on the next time and then zoom adjustment is made (the zoom drive mechanism is operated) so that a desired zoom ratio is achieved, it takes long in some cases for the zoom ratio to reach the desired value. For example, when the initial zoom ratio has been set to the largest value and the desired zoom ratio is small, it takes long for the zoom ratio to reach the desired value because the amount of action of the zoom mechanism in the projection lens is large. On the other hand, when the initial zoom ratio has been set to the smallest value and the desired zoom ratio is large, it takes long for the zoom ratio to reach the desired value because the amount of action of the zoom mechanism in the projection lens is large.

### SUMMARY

An advantage of some aspects of the invention is to solve at least part of the problems described above and the invention can be implemented as the following forms or aspects.

A projector according to an aspect of the invention includes a projection lens including a zoom mechanism, a zoom drive unit that drives the zoom mechanism, a zoom amount storage unit that stores an amount of zooming produced by the zoom drive unit, an operation signal receiving unit that receives a predetermined operation signal, and a zoom control unit that controls the zoom drive unit so as to change a current zooming state to an initial zooming state when the operation signal receiving unit receives the predetermined operation signal, the initial zooming state is determined by the amount of zooming stored in the zoom amount storage unit.

According to the projector described above, next time when the zoom mechanism is operated to have a desired zooming state, the operation starts from the initial zooming state based on the past zooming state stored in the zoom amount storage unit (based on the state how a user used the projector in the past), whereby the travel of a zoom lens can be reduced. The period during which the zoom lens is moved can also be reduced.

A method for controlling a projector according to another aspect of the invention controls a projector including a projection lens including a zoom mechanism, a zoom drive unit that drives the zoom mechanism, and a zoom amount storage unit that stores an amount of zooming produced by the zoom drive unit. The method includes receiving a predetermined operation signal and controlling the zoom drive unit so as to change a current zooming state to an initial zooming state when the predetermined operation signal is received, the initial zooming state is determined by the amount of zooming stored in the zoom amount storage unit.

According to the method for controlling a projector described above, when the predetermined operation signal is received, the zoom drive unit is controlled to drive the zoom mechanism in such a way that an initial zooming state based on the smallest and largest amounts of zooming stored in the zoom amount storage unit is achieved. In this way, next time when the zoom mechanism is operated to have a desired zooming state, the operation starts from the initial zooming state based on the past zooming state stored in the zoom amount storage unit, whereby the travel of the zoom lens can be reduced. The period during which the zoom lens is moved can also be reduced.

In the projector according to the aspect described above, the initial zooming state represents the median amount of zooming between the smallest amount of zooming and the largest amount of zooming stored in the zoom amount storage unit. In this way, next time when the zoom mechanism is operated to have a desired zooming state, the period during which the zoom mechanism is operated can be reduced.

In the projector according to the aspect described above, the initial zooming state represents the amount of zooming that allows a first zoom operation period during which the zoom drive unit is operated to achieve the smallest amount of zooming stored in the zoom amount storage unit to coincide with a second zoom operation period during which the zoom drive unit is operated to achieve the largest amount of zooming stored in the zoom amount storage unit. In this way, next time when the zoom mechanism is operated to have a desired zooming state, the period during which the zoom mechanism is operated can be reduced.

In the projector according to the aspect described above, the initial zooming state represents the last used amount of zooming, that is, the amount of zooming produced when the projector was used last time, stored in the zoom amount storage unit. In this way, when the projector is used in a conference room or a projection room where the projection environment is fixed, it is not necessary to adjust the zooming state next time when the projector is activated, whereby the projector becomes ready quickly to project an image.

In the projector according to the aspect described above, the predetermined operation signal received by the operation signal receiving unit is a power-on operation signal or a power-off operation signal. In this way, when the user turns on the projector, the projection lens has a predetermined zooming state, whereby next time when the zoom mechanism is operated, the operation can start from the predetermined zooming state. Alternatively, the zoom mechanism may be driven to achieve the initial zooming state in response to the power-off operation signal. In this way, when the user turns off the projector, the zooming state of the projector is set to the initial zooming state, whereby next time when the zoom mechanism is operated after the projector is turned on, the operation can start from the predetermined zooming state. It is therefore not necessary to set the zooming state to the predetermined zooming state when the projector is powered on, whereby the period required for an initial process carried out when the projector is powered on can be reduced.

When the projector and the method for controlling the same described above are implemented by using a computer provided in the projector, the forms and the aspects described above can be formed of a program for achieving the function of the forms and the aspects described above or a recording medium or any other suitable component on which the program is recorded so that the computer can read the program. Examples of the recording medium may include a flexible disk, a CD-ROM, a magneto-optical disk, an IC card, a ROM cartridge, a punched card, printed matter on which barcodes or any other suitable characters are printed, an internal storage device in the projector (RAM, ROM, or any other suitable memory), an external storage device, and any other variety of computer readable medium.

### BRIEF DESCRIPTION OF THE DRAWINGS

The invention will be described with reference to the accompanying drawings, wherein like numbers reference like elements.

FIG. 1 is a block diagram showing an internal configuration of a projector according to a first embodiment.

FIG. 2A shows the zooming state corresponding to the smallest angle of projection field; FIG. 2B shows the zooming state corresponding to the largest angle of projection field; and FIG. 2C shows the zooming state corresponding to the median angle of projection field.

FIG. 3 is a flowchart showing processes carried out when the projector is powered on.

FIG. 4 is a flowchart showing the procedure of zoom adjustment and keystone correction.

FIG. 5A shows how an image is projected on a screen before the zoom adjustment and keystone correction, and FIG. 5B shows how the image is projected on the screen after the zoom adjustment and keystone correction.

FIG. 6 is a flowchart showing processes carried out when the projector is powered off.

FIG. 7 is a block diagram showing an internal configuration of a projector according to a third embodiment.

FIG. 8 shows the area configuration of a zoom amount storage unit.

FIG. 9 is a flowchart showing processes carried out when the projector is powered on.

FIG. 10 is a flowchart showing processes carried out when the projector is powered off.

FIG. 11 is a block diagram showing an internal configuration of a projector according to a seventh embodiment.

### DESCRIPTION OF EXEMPLARY EMBODIMENTS

Embodiments will be described below.

### First Embodiment

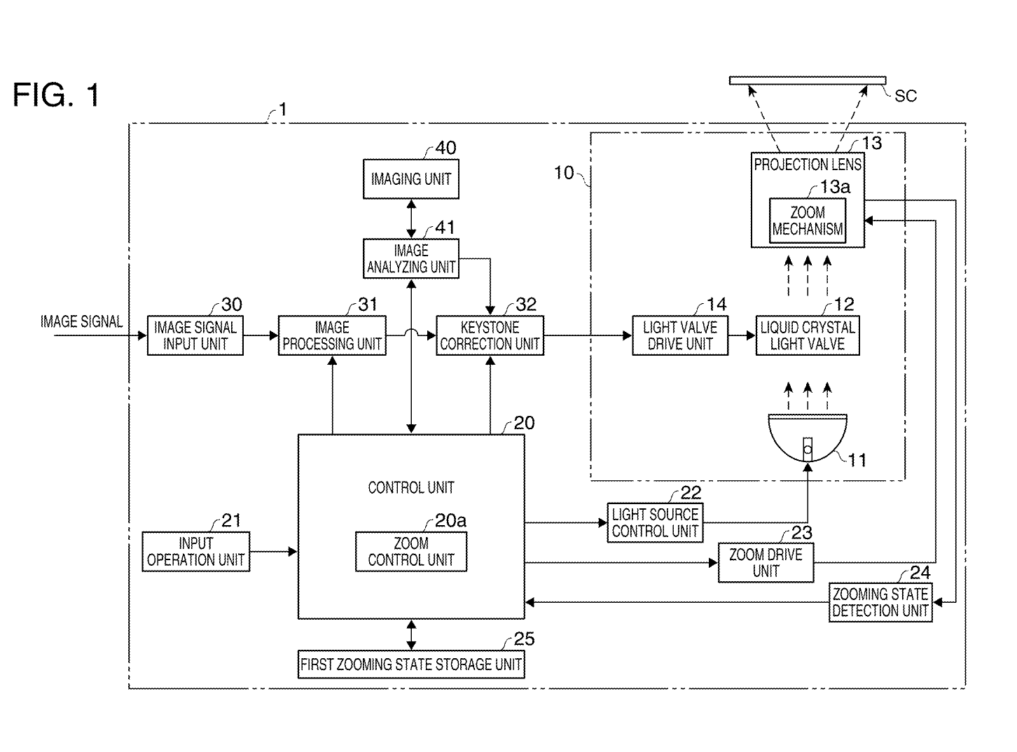

FIG. 1 is a block diagram showing an internal configuration of a projector 1 according to a first embodiment. The internal configuration of the projector 1 will be described with reference to FIG. 1.

The projector 1 includes an image projection unit 10, a control unit 20, an input operation unit 21, a light source control unit 22, a zoom drive unit 23, a zooming state detection unit 24, a first zooming state storage unit 25, an image signal input unit 30, an image processing unit 31, a keystone correction unit 32, an imaging unit 40, and an image analyzing unit 41. The control unit 20 also serves as an operation signal receiving unit. FIG. 1 also shows a screen SC external to the projector 1.

The image projection unit 10 includes a light source 11 formed of an ultra-high pressure mercury lamp, a metal halide lamp, or any other suitable discharge-type light source, or an LED (Light Emitting Diode) or any other suitable solid-state light source, a liquid crystal light valve 12 as a light modulator, a projection lens 13, and a light valve drive unit 14 that drives the liquid crystal light valve 12.

The liquid crystal light valve 12 is formed, for example, of a transmissive liquid crystal panel in which liquid crystal molecules are sealed between a pair of transparent substrates. When the light valve drive unit 14 applies a drive voltage according to an image signal to pixels of the liquid crystal light valve 12, the pixels transmit the light-source light at light transmission factors according to the image signal.

The light emitted from the light source 11 passes through the liquid crystal light valve 12, whereby the light is modulated, and the modulated light is projected through the projection lens 13. An image according to the image signal is thus displayed on the screen SC or any other suitable surface.

The projection lens 13 includes a zoom mechanism 13a, which can change the state of zooming to adjust the angle of projection field.

The control unit 20 includes a CPU (Central Processing Unit), a RAM (Random Access Memory) used, for example, to temporarily store a variety of data, and a mask ROM (Read Only Memory), a flash memory, an FeRAM (Ferroelectric RAM), or any other suitable non-volatile memory (none of the above components are shown). The control unit 20 therefore functions as a computer. The control unit 20 operates in accordance with a control program stored in the non-volatile memory to perform centralized control of the operation of the projector 1. The control unit 20 further includes a zoom control unit 20a.

The zoom control unit 20a reads the initial amount of zooming representing a first zooming state, that is, an initial zooming state, from the first zooming state storage unit 25. The zoom control unit 20a further receives an optimum zooming state based on automatic zoom adjustment, which will be described later, from the image analyzing unit 41 and calculates the optimum amount of zooming. The zoom control unit 20a controls the zoom drive unit 23 to drive the zoom mechanism 13a based on the amounts of zooming described above. The zoom control unit 20a further writes the latest amount of zooming representing the first zooming state in the first zooming state storage unit 25 after the first zooming state is changed. The zoom control unit 20a further receives the amount of zooming representing the zooming state from the zooming state detection unit 24 and determines the zooming state of the projection lens 13.

The input operation unit 21 includes a plurality of keys for issuing a variety of instructions to the projector 1. Examples of the keys provided on the input operation unit 21 include a “power-on/off” key for turning the projector 1 on and off, an “automatic zoom key” for performing the automatic zoom adjustment, a “menu key” for switching a menu screen through which a variety of settings are inputted between displayed and non-displayed modes, a “cursor key” used, for example, to move a cursor across the menu screen, and an “enter key” for finalizing the variety of settings. When a user operates the input operation unit 21, the input operation unit 21 outputs an operation signal according to the user's operation to the control unit 20. The input operation unit 21 may alternatively be a remote controller (not shown) capable of remotely communicating with a remote controller signal receiver (not shown). In this case, the remote controller issues an operation signal, for example, in the form of infrared light according to the user's operation, and the remote controller signal receiver receives the operation signal and transfers it to the control unit 20.

The light source control unit 22 starts and stops supplying electric power to the light source 11 based on an instruction from the control unit 20 to switch the state of the light source 11 between light-on and light-off states.

The zoom drive unit 23 is formed, for example, of a motor and a gear and drives the zoom mechanism 13a under the control of the zoom control unit 20a to change the zooming state of the projection lens 13.

The zooming state detection unit 24 detects the zooming state of the zoom mechanism 13a in the form of the amount of zooming and then outputs the amount of zooming having been detected to the zoom control unit 20a. In the present embodiment, the detection of the amount of zooming is carried out by detecting the amount of change in the zoom mechanism 13a by using an encoder or any other suitable device. The detection of the amount of zooming may alternatively be carried out by using a stepper motor as the motor of the zoom drive unit 23 and detecting the amount of zooming based on the number of steps the stepper motor has experienced.

The first zooming state storage unit 25 is formed of a non-volatile memory and stores the amount of zooming in the first zooming state as the initial amount of zooming. The zoom control unit 20a reads the amount of zooming having been stored. The amount of zooming in the first zooming state may be measured and stored for each product (projector), whereby an accurate amount of zooming in consideration of individual product difference can be stored.

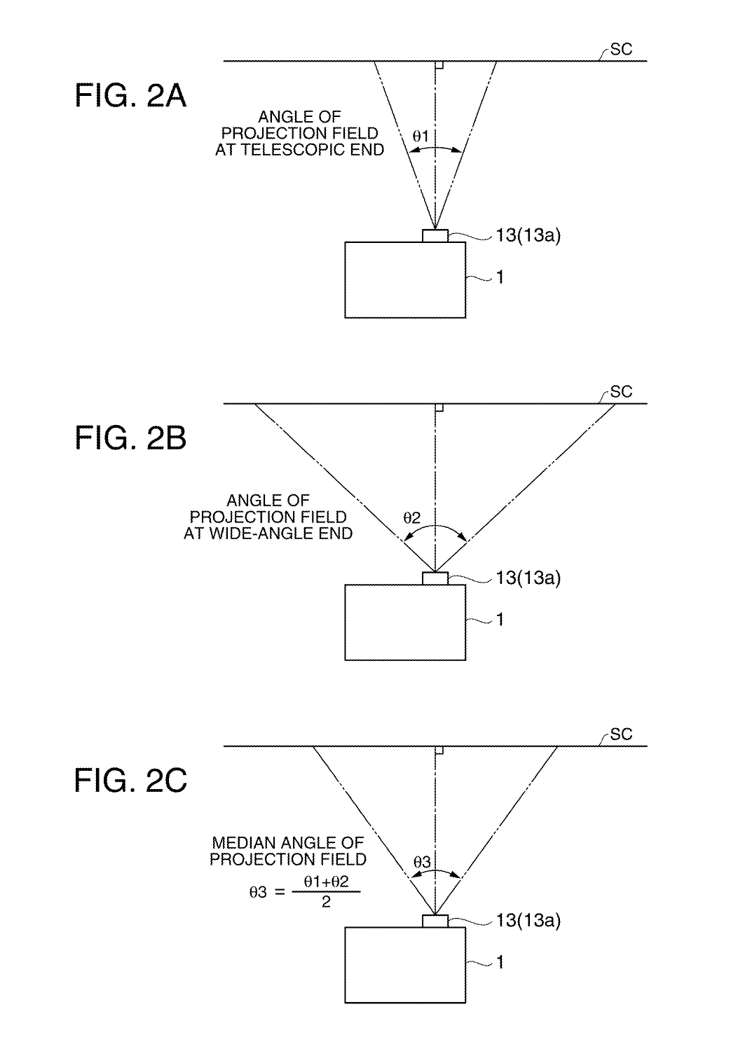

A description will be made of the first zooming state, that is, the zooming state corresponding to the median value between the angle of projection field at a telescopic end of the projection lens 13 and the angle of projection field at a wide-angle end of the projection lens 13. FIGS. 2A to 2C are top views describing the angle of projection field of the projector 1. FIG. 2A shows the zooming state in which the angle of projection field has the smallest value (telescopic end). FIG. 2B shows the zooming state in which the angle of projection field has the largest value (wide-angle end). FIG. 2C shows the zooming state in which the angle of projection field has the median value. It is noted in the present embodiment that the angle of projection field is expressed in a horizontal angle to simplify the description.

As shown in FIG. 2A, let θ1 be the angle of projection field when the zoom mechanism 13a of the projection lens 13 in the projector 1 has the zooming state corresponding to the smallest possible adjustable value (telescopic end). As shown in FIG. 2B, let θ2 be the angle of projection field when the zoom mechanism 13a of the projection lens 13 in the projector 1 has the zooming state corresponding to the largest possible adjustable value (wide-angle end).

As shown in FIG. 2C, let θ3 be the median angle of projection field between the angle of projection field θ1, which is the smallest possible adjustable value (telescopic end) of the zoom mechanism 13a of the projection lens 13 in the projector 1, and the angle of projection field θ2, which is the largest possible adjustable value (wide-angle end) of the zoom mechanism 13a of the projection lens 13 in the projector 1. The median angle of projection field θ3 is calculated by the following equation (1):

θ3=(θ1+θ2)/2

The state in which the angle of projection field is θ3 expressed in Equation (1) is referred to as the first zooming state.

The first zooming state storage unit 25 stores the amount of zooming in the first zooming state, that is, the amount of zooming when the angle of projection field is θ3.

Referring to FIG. 1 again, the image signal input unit 30 has a variety of image input terminals to be connected to a personal computer, a video reproducing apparatus, and other external image supplying apparatus (not shown) via cables, and an image signal is inputted from any of the image supplying apparatus. The image signal input unit 30 converts the inputted image signal into image data in a form processable by the image processing unit 31 and outputs the image data to the image processing unit 31.

The image processing unit 31 performs a variety of image quality adjustment operations, such as adjustment in brightness, contrast, sharpness, and coloration, and gamma correction, on the image data inputted from the image signal input unit 30. The image processing unit 31 further superimposes an OSD (On-Screen Display) image on the image data as required. The image processing unit 31 outputs the image data having undergone the adjustment and processing to the keystone correction unit 32.

The keystone correction unit 32 corrects the inputted image data to suppress trapezoidal distortion produced when the projector 1 is inclined and projects an image on the screen SC. The control unit 20 or the image analyzing unit 41 inputs information required for the correction. The corrected image data is then outputted to the light valve drive unit 14. When no information required for the trapezoidal distortion correction is available, no correction is made and the image data outputted from the image processing unit 31 is directly outputted to the light valve drive unit 14.

The light valve drive unit 14 drives the liquid crystal light valve 12 in accordance with the inputted image data. As a result, the image projection unit 10 projects an image based on the image data on the screen SC.

The imaging unit 40 includes a CCD camera and is disposed in a plane flush with the plane through which the projection lens 13 protrudes from a housing of the projector 1. The imaging unit 40 captures the image projected on the screen SC and outputs the captured image to the image analyzing unit 41 in response to an instruction from the image analyzing unit 41. The imaging unit 40 does not necessarily include a CCD camera but may include any other imaging device.

The image analyzing unit 41 analyzes the image data of the captured image captured by the imaging unit 40 in response to an instruction from the control unit 20 and performs “detection of an entire projection area frame and a screen frame,” “projective transformation of the entire projection area frame and the screen frame,” “calculation of an optimum zooming state,” “output of information required for the keystone correction,” and other processing associated with the automatic zoom adjustment. The automatic zoom adjustment will be described later.

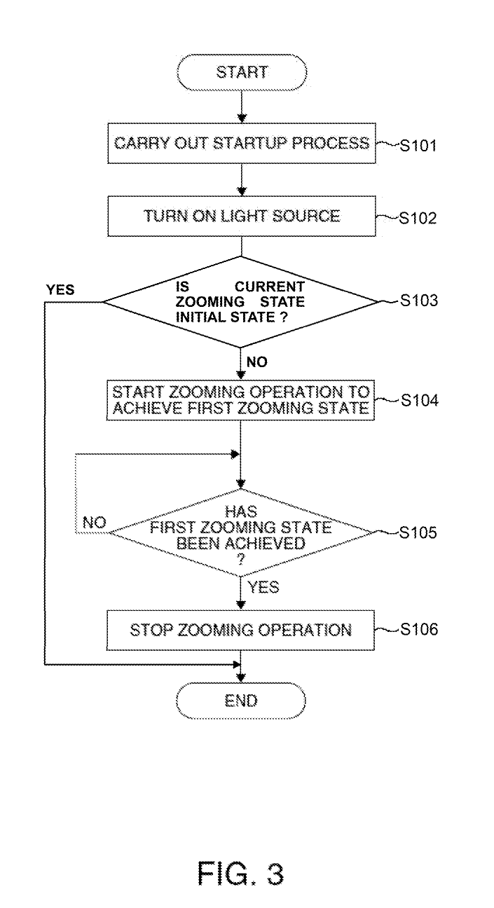

The operation of the projector 1 when it is powered on will next be described. FIG. 3 is a flowchart showing processes carried out when the projector is powered on.

When the power-on/off key provided on the input operation unit 21 is pressed and an operation signal that causes the projector 1 to be powered on is inputted, the control unit 20 carries out a startup process (step S101). In the present embodiment, the startup process includes initialization of the CPU, the RAM, and other hardware. The control unit 20 then instructs the light source control unit 22 to turn on the light source 11 (step S102).

The zoom control unit 20a then reads the initial amount of zooming representing the first zooming state from the first zooming state storage unit 25 and compares the current zooming state to the first zooming state. If the current zooming state is equal to the first zooming state or the initial state of zooming, the zoom control unit 20a passes the adjustment of zooming state (step S103: YES). If the current zooming state is not in the first zooming state (step S103: NO), the zoom control unit 20a starts driving the zoom mechanism 13a through the zoom drive unit 23 to achieve the first zooming state (step S104). The zoom control unit 20a then judges whether or not the first zooming state has been achieved (step S105). The zoom control unit 20a waits until the first zooming state has been achieved (step S105: NO). When the first zooming state has been achieved (step S105: YES), the zoom control unit 20a stops driving the zoom drive unit 23 (step S106). The processes carried out when the projector 1 is powered on are then terminated.

As described above, when the projector 1 is powered on, the zoom drive unit 23 sets the state of the zoom mechanism 13a to the first zooming state. That is, the state of the zoom mechanism 13a is set to the zooming state corresponding to the median angle of projection field θ3 between the smallest (telescopic-end) angle of projection field θ1 and the largest (wide-angle-end) angle of projection field θ2.

The automatic zoom adjustment in the projector 1 will next be described. The automatic zoom adjustment in the following description is the same process as that of the zoom adjustment and keystone correction process disclosed in JP-A-2006-5534. Only a summary of the process will therefore be described.

The projector 1 can make automatic zoom adjustment in which zoom adjustment and keystone correction are automatically made. The zoom adjustment is a process of adjusting the zooming state in such a way that a projected image does not lie off the screen SC but is displayed at a highest possible magnification. The keystone correction is a process of correcting trapezoidal distortion of an image displayed on the screen SC. The automatic zoom adjustment is made when the user presses the automatic zoom key provided on the input operation unit 21. The automatic zoom adjustment can alternatively be automatically made, for example, at the time of power-on or at the timing when an image signal is inputted.

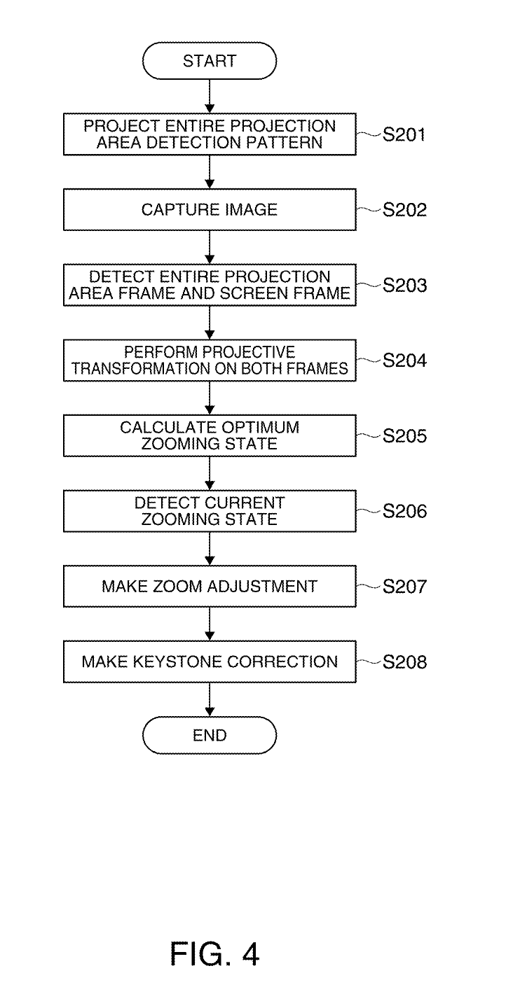

FIG. 4 is a flowchart showing the procedure of the automatic zoom adjustment (the same flowchart as that shown in FIG. 3 of JP-A-2006-5534 but the step numbers are different).

In step S201, the image processing unit 31 projects an entire projection area detection pattern. The entire projection area means the area on the screen SC or on a wall behind the screen SC on which image light corresponding to the entire area in an image formation area of the liquid crystal light valve 12 is projected. The image formation area means the area on the panel surface of the liquid crystal light valve 12 on which the image data signal inputted to the light valve drive unit 14 can be displayed.

In step S202, the imaging unit 40 captures an image of the entire projection area and the screen SC, produces a captured image containing the entire projection area and the screen SC, and stores the captured image in a captured image memory (not shown). The optical axis of a lens of the CCD camera in the imaging unit 40 is set to be substantially parallel to the optical axis of the projection lens 13. The optical axis of the lens of the CCD camera is not, however, precisely set to be parallel to the optical axis of the projection lens 13, and the entire projection area frame is therefore slightly distorted into a trapezoidal shape.

In step S203, the image analyzing unit 41 analyzes the image data of the captured image to detect the entire projection area frame and the screen frame. The entire projection area frame represents the outer circumference of the entire projection area in which the image light corresponding to the entire area in the image formation area of the panel surface of the liquid crystal light valve 12 is projected. A black frame along the outer circumference of the screen SC is referred to as the screen frame. The entire projection area frame and the screen frame are detected by measuring the contrast ratio in the captured image and extracting pixels having a large contrast ratio.

In step S204, the image analyzing unit 41 performs projective transformation on the entire projection area frame and the screen frame. The projective transformation is performed to compensate the deviation of the optical axis of the lens of the CCD camera in the imaging unit 40 from the optical axis of the projection lens 13.

In step S205, the image analyzing unit 41 calculates an optimum zooming state. The optimum zooming state means a zooming state that allows an image to be displayed on screen SC at a highest possible magnification and suppressing the decrease in the resolution of effective image that is formed on the panel surface of the liquid crystal light valve 12 being led by the keystone correction.

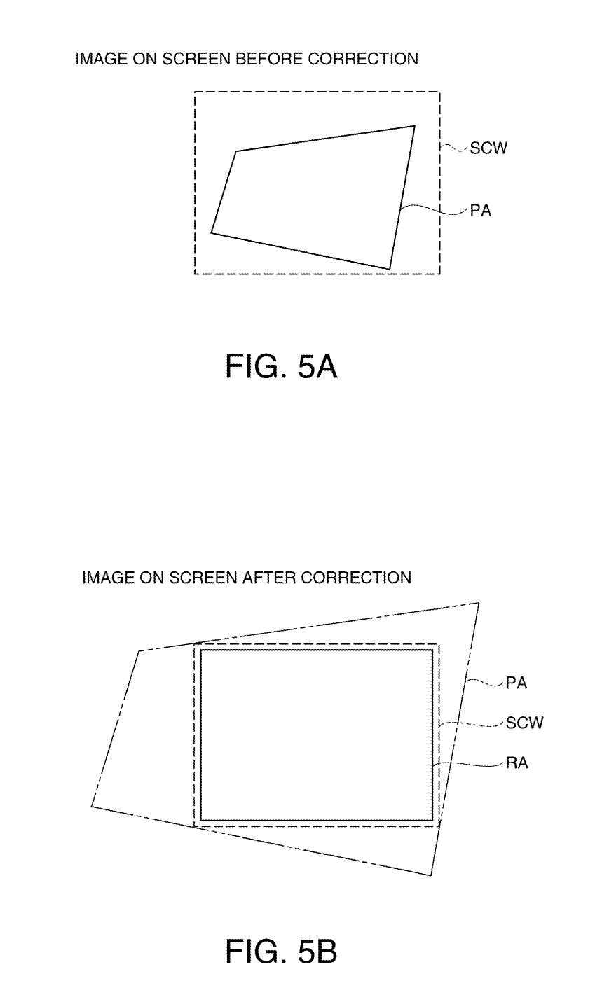

FIGS. 5A and 5B describe how an image is projected on the screen. FIG. 5A shows how an image is projected before the automatic zoom adjustment, and FIG. 5B shows how the image is projected after the automatic zoom adjustment. The optimum zooming state is a zooming state in which the entire projection area PA encompasses the screen SC and the outer circumference of the entire projection area PA is in contact with the outer circumference of the screen SC (screen frame SCW). The entire projection area frame in the state described above is referred to as an entire projection area frame after optimum zoom adjustment. Once the entire projection area frame after optimum zoom adjustment is determined, the magnification with respect to the entire projection area frame (optimum magnification Mb) is calculated.

Referring to FIG. 4 again, in step S206, the zooming state detection unit 24 detects the current zooming state of the projection lens 13. Let Zp be the amount of zooming corresponding to the detected current zooming state.

In step S207, the zoom control unit 20a instructs the zoom drive unit 23 to make zoom adjustment. The zoom adjustment is made in such a way that the amount of zooming corresponds to the optimum zooming state (hereinafter referred to as an “optimum amount of zooming”). The optimum amount of zooming is calculated by multiplying the current amount of zooming Zp calculated in step S206 by the optimum magnification Mb calculated in step S205.

In step S208, the keystone correction unit 32 makes keystone correction based on information required for keystone correction inputted from the image analyzing unit 41. To project an image only in an area (corrected projection area RA) within the screen SC in the entire projection area PA, the keystone correction in the present embodiment is made by forming the effective panel image only in the area (corrected image formation area) in the image formation area of the liquid crystal light valve 12 that corresponds to the corrected projection area RA. A totally black image is formed in the area other than the corrected image formation area in the image formation area so that the light emitted from the light source 11 will not pass through the area.

After the automatic zoom adjustment, the corrected projection area RA falls within the screen frame SCW of the screen SC, as shown in FIG. 5B, which means that the zooming state has been optimized and the keystone correction has been made. No image light is projected in the area other than the corrected projection area RA in the entire projection area PA. It is noted that FIG. 5A shows an image on the screen before the automatic zoom adjustment.

As described above, the projector 1 of the present embodiment can make the automatic zoom adjustment. In this process, since the corrected image formation area in the image formation area of the liquid crystal light valve 12 is set to have a largest possible size, decrease in resolution of the effective panel image can be reduced.

According to the first embodiment described above, the following advantage is provided:

1. The projector 1 is set to have the first zooming state when it is powered on. The zooming state therefore transits from the first zooming state to the optimum zooming state when the automatic zoom adjustment is made. That is, since the zooming state starts from the zooming state corresponding to the median angle of projection field θ3 between the smallest (telescopic-end) angle of projection field θ1 and the largest (wide-angle-end) angle of projection field θ2 and is changed to the optimum zooming state, the amount of angular change in the angle of projection field is smaller than or equal to Δθ calculated by the following equation (2) at the maximum, whereby the amount of angular change can be reduced. The period during which the zoom mechanism 13a is operated can also be reduced.

Δθ=(θ2−θ1)/2

### Second Embodiment

A second embodiment will be described below.

The configuration of a projector 2 according to the second embodiment is similar to that in the first embodiment but differs therefrom only in terms of the timing at which the zoom drive unit 23 is driven to set the zooming state to the first zooming state. In the first embodiment, the zooming state is set to the first zooming state when the projector 1 is powered on, whereas in the present embodiment, the zooming state is not set to the first zooming state when the projector 2 is powered on but the zooming state is set to the first zooming state when the projected 2 is powered off. The automatic zoom adjustment is made in the same manner as in the first embodiment.

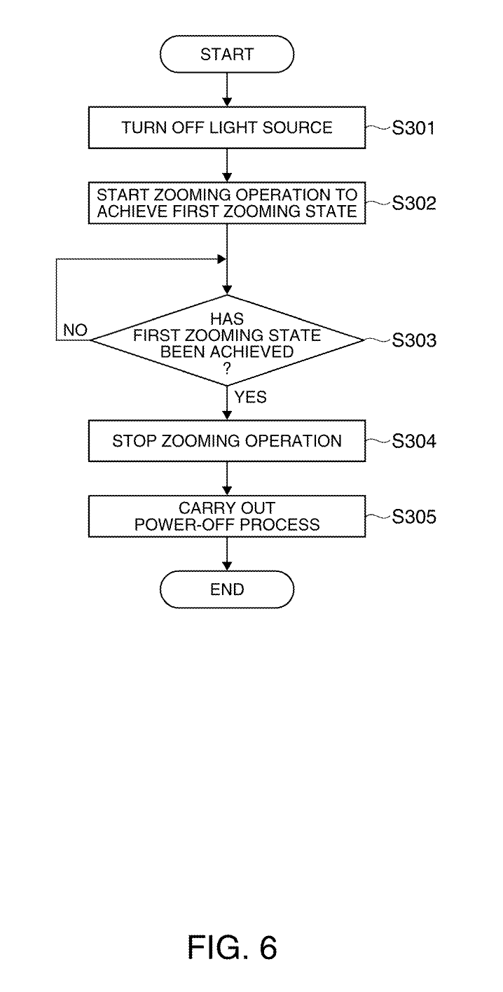

The operation of the projector 2 when it is powered off will be described. FIG. 6 is a flowchart showing processes carried out when the projector 2 is powered off.

When the power-on/off key provided on the input operation unit 21 is pressed and an operation signal that causes the projector 2 to be powered off is inputted, the control unit 20 instructs the light source control unit 22 to turn off the light source 11 (step S301).

The zoom control unit 20a then reads the amount of zooming representing the first zooming state from the first zooming state storage unit 25 and starts driving the zoom mechanism 13a through the zoom drive unit 23 to achieve the first zooming state (step S302). The zoom control unit 20a then judges whether or not the first zooming state has been achieved (step S303). The zoom control unit 20a waits until the first zooming state has been achieved (step S303: NO). When the first zooming state has been achieved (step S303: YES), the zoom control unit 20a stops driving the zoom drive unit 23 (step S304).

The control unit 20 then carries out a power-off process (step S305). The processes carried out when the projector 2 is powered off are thus terminated. In the present embodiment, the power-off process is a process carried out when the projector 2 is powered off and includes software and hardware processes corresponding to the power-off action.

As described above, when the projector 2 is powered off, the zoom drive unit 23 sets the state of the zoom mechanism 13a to the first zooming state. That is, the state of the zoom mechanism 13a is set to the zooming state corresponding to the median angle of projection field θ3 between the smallest (telescopic-end) angle of projection field θ1 and the largest (wide-angle-end) angle of projection field θ2.

According to the second embodiment described above, the following advantages are provided:

1. The projector 2 is set to have the first zooming state when it is powered off. The zooming state therefore transits from the first zooming state to the optimum zooming state when the automatic zoom adjustment is made. That is, since the zooming state starts from the zooming state corresponding to the median angle of projection field θ3 between the smallest (telescopic-end) angle of projection field θ1 and the largest (wide-angle-end) angle of projection field θ2 and is changed to the optimum zooming state, the amount of angular change in the angle of projection field is smaller than or equal to Δθ calculated by the equation (2) described above at the maximum, whereby the amount of angular change can be reduced. The period during which the zoom mechanism 13a is operated can also be reduced.

2. Since the projector 2 is set to have the first zooming state when it is powered off, it is not necessary to set the zooming state to the first zooming state next time when the projector 2 is powered on. The period required for an initial process when the projector 2 is powered on can therefore be reduced.

### Third Embodiment

A third embodiment will be described below.

In the configuration of a projector 3 according to the third embodiment, the first zooming state storage unit 25 in the first embodiment is replaced with a zoom amount storage unit 26 and the zoom control unit 20a carries out different processes. The other components in this embodiment are the same as those in the first embodiment. The automatic zoom adjustment is made in the same manner as in the first embodiment.

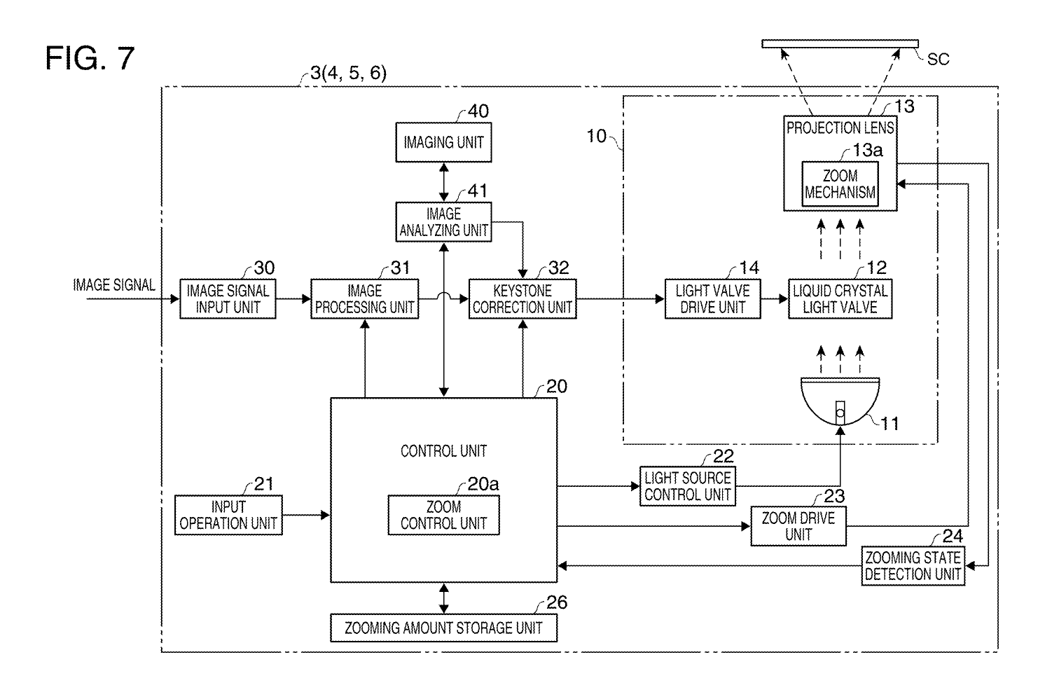

FIG. 7 is a block diagram showing an internal configuration of the projector 3 according to the third embodiment. The difference in the internal configuration between the projector 3 and the projector 1 will be described with reference to FIG. 7.

The zoom amount storage unit 26 is formed of a non-volatile memory and stores the smallest and largest amounts of zooming produced by the zoom drive unit 23 based on user's input operations. The zoom amount storage unit 26 further stores, as default values, the smallest and largest adjustable amounts of zooming that can be produced by the zoom mechanism 13a.

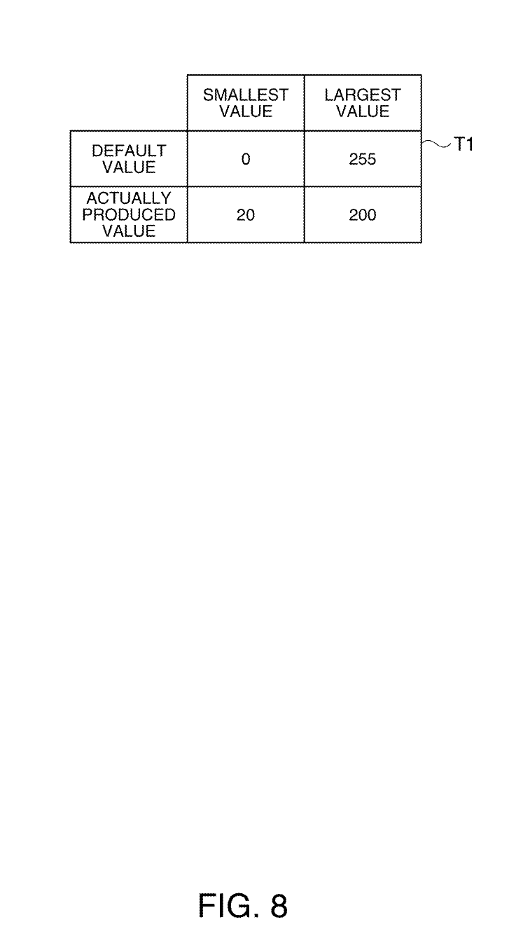

FIG. 8 shows the area configuration of the zoom amount storage unit 26. As shown in FIG. 8, a storage area T1 of the zoom amount storage unit 26 stores the smallest amount of zooming (value at telescopic end) and the largest amount of zooming (value at wide-angle end) as default values as well as the smallest and largest amounts of zooming actually produced in the past when zoom adjustment was made. The zoom adjustment may be the automatic zoom adjustment or manual zoom adjustment. The default values are stored in advance.

Referring to FIG. 7 again, the zoom control unit 20a reads any of the amounts of zooming stored in the zoom amount storage unit 26 and calculates the initial amount of zooming representing a second zooming state. The zoom control unit 20a also receives the optimum zooming state from the image analyzing unit 41 and calculates the optimum amount of zooming. The zoom control unit 20a controls the zoom drive unit 23 to drive the zoom mechanism 13a based on the amounts of zooming described above.

When the zoom adjustment is made, the zoom control unit 20a receives the amount of zooming representing the zooming state from the zooming state detection unit 24. When the amount of zooming is smaller than the smallest actually produced past value stored in the zoom amount storage unit 26, the smallest actually produced past value in the zoom amount storage unit 26 is overwritten with the amount of zooming having been detected. That is, the smallest actually produced past value is updated. On the other hand, when the amount of zooming is greater than the largest actually produced past value stored in the zoom amount storage unit 26, the largest actually produced past value in the zoom amount storage unit 26 is overwritten with the amount of zooming having been detected. That is, the largest actually produced past value is updated. When the latest amount of zooming having been detected is smaller than the smallest actually produced past value, the actually produced past value may be immediately updated. When the latest amount of zooming having been detected is greater than the largest actually produced past value, the actually produced past value may be immediately updated. The actually produced past values may alternatively be overwritten when the projector 3 is powered off.

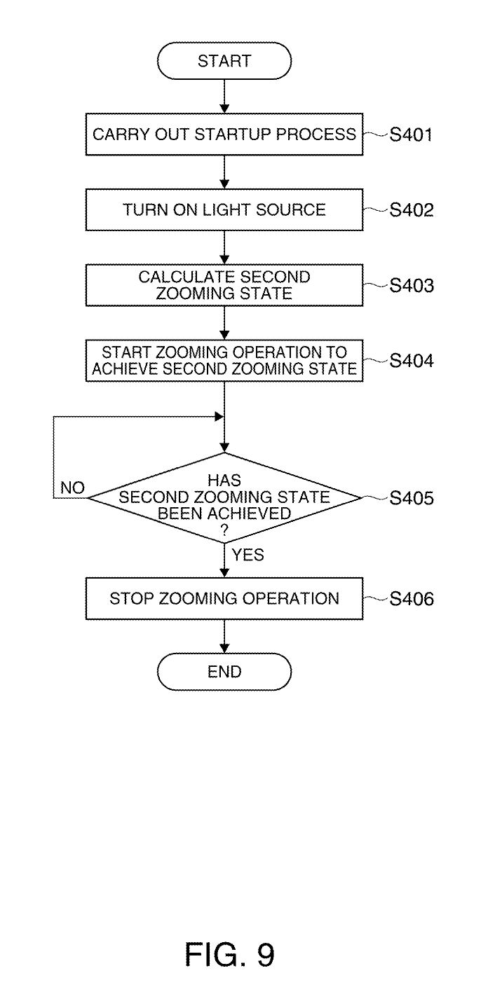

The operation of the projector 3 when it is powered on will next be described. FIG. 9 is a flowchart showing processes carried out when the projector 3 is powered on.

When the power-on/off key provided on the input operation unit 21 is pressed and an operation signal that causes the projector 3 to be powered on is inputted, the control unit 20 carries out a startup process (step S401). The control unit 20 then instructs the light source control unit 22 to turn on the light source 11 (step S402).

The zoom control unit 20a then reads the smallest and largest actually produced past values from the zoom amount storage unit 26, calculates the median value (average) of the smallest and largest values, and set the amount of zooming representing the second zooming state at the calculated median value (step S403). When no actually produced past value is available, the smallest and largest values, which are the default values, in the zoom amount storage unit 26 are used. The zoom control unit 20a then starts driving the zoom mechanism 13a through the zoom drive unit 23 to achieve the second zooming state (step S404). The zoom control unit 20a then judges whether or not the second zooming state has been achieved (step S405). The zoom control unit 20a waits until the second zooming state has been achieved (step S405: NO). When the second zooming state has been achieved (step S405: YES), the zoom control unit 20a stops driving the zoom drive unit 23 (step S406). The processes carried out when the projector 3 is powered on are then terminated.

As described above, when the projector 3 is powered on, the zoom drive unit 23 sets the state of the zoom mechanism 13a to the second zooming state. That is, the state of the zoom mechanism 13a is set to the zooming state based on the median amount of zooming between the smallest actually produced past amount of zooming and the largest actually produced past amount of zooming.

According to the third embodiment described above, the following advantage is provided:

1. The projector 3 is set to have the second zooming state when it is powered on. The zooming state therefore transits from the second zooming state to the optimum zooming state when the automatic zoom adjustment is made. That is, the zooming state starts from the zooming state corresponding to the median amount of zooming between the smallest actually produced past amount of zooming and the largest actually produced past amount of zooming and is changed to the optimum zooming state. As a result, since the past values actually produced by the user (zooming range having been used) are reflected, and the zooming operation starts from the vicinity of a user's preferred zooming state, the travel produced in the zooming operation can be reduced. The period during which the zooming operation is carried out can also be reduced.

### Fourth Embodiment

A fourth embodiment will be described below.

The configuration of a projector 4 according to the fourth embodiment is similar to that in the third embodiment but differs therefrom only in terms of the timing at which the second zooming state is calculated and set. In the third embodiment, the second zooming state is calculated and set when the projector 3 is powered on, whereas in the present embodiment, the second zooming state is not calculated or set when the projector 4 is powered on but the second zooming state is calculated and set when the projected 4 is powered off. The automatic zoom adjustment is made in the same manner as in the first embodiment.

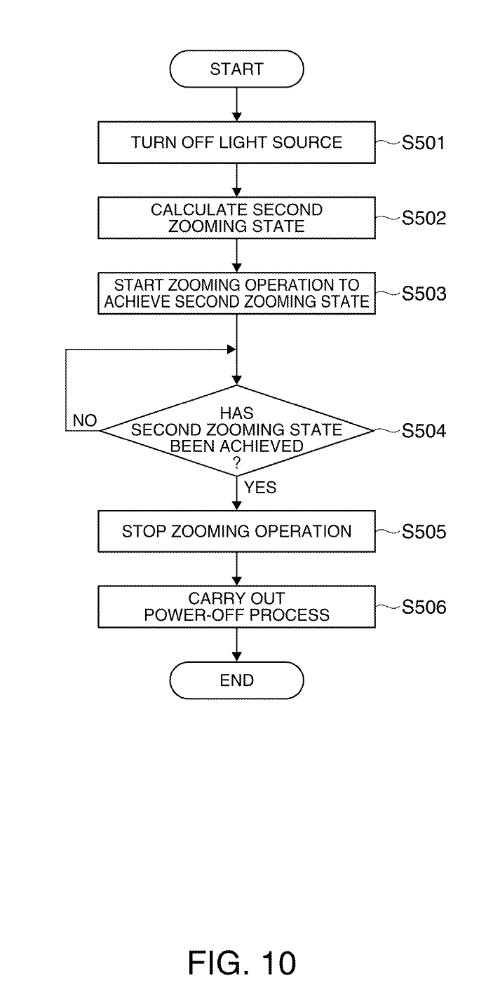

The operation of the projector 4 when it is powered off will be described. FIG. 10 is a flowchart showing processes carried out when the projector 4 is powered off.

When the power-on/off key provided on the input operation unit 21 is pressed and an operation signal that causes the projector 4 to be powered off is inputted, the control unit 20 instructs the light source control unit 22 to turn off the light source 11 (step S501).

The zoom control unit 20a then reads the smallest and largest actually produced past values from the zoom amount storage unit 26, calculates the median value (average) of the smallest and largest values, and set the amount of zooming representing the second zooming state at the calculated median value (step S502). When no actually produced past value is available, the smallest and largest values, which are the default values, in the zoom amount storage unit 26 are used. The zoom control unit 20a then starts driving the zoom mechanism 13a through the zoom drive unit 23 to achieve the second zooming state (step S503). The zoom control unit 20a then judges whether or not the second zooming state has been achieved (step S504). The zoom control unit 20a waits until the second zooming state has been achieved (step S504: NO). When the second zooming state has been achieved (step S504: YES), the zoom control unit 20a stops driving the zoom drive unit 23 (step S505).

The control unit 20 then carries out a power-off process (step S506). The processes carried out when the projector 4 is powered off are thus terminated.

As described above, when the projector 4 is powered off, the zoom drive unit 23 sets the state of the zoom mechanism 13a to the second zooming state. That is, the state of the zoom mechanism 13a is set to the zooming state based on the median amount of zooming between the smallest actually produced past amount of zooming and the largest actually produced past amount of zooming.

According to the fourth embodiment described above, the following advantages are provided:

1. The projector 4 is set to have the second zooming state when it is powered off. The zooming state therefore transits from the second zooming state to the optimum zooming state when the automatic zoom adjustment is made. That is, the zooming state starts from the zooming state corresponding to the median amount of zooming between the smallest actually produced past amount of zooming and the largest actually produced past amount of zooming and is changed to the optimum zooming state. As a result, since the past values actually produced by the user (zooming range having been used) are reflected, and the zooming operation starts from the vicinity of a user's preferred zooming state, the travel produced in the zooming operation can be reduced. The period during which the zooming operation is carried out can also be reduced.

2. Since the projector 4 is set to have the second zooming state when it is powered off, it is not necessary to set the zooming state to the second zooming state next time when the projector 4 is powered on. The period required for an initial process when the projector 4 is powered on can therefore be reduced.

### Fifth Embodiment

A fifth embodiment will be described below.

The configuration of a projector 5 according to the fifth embodiment is similar to that in the third embodiment.

FIG. 7 is a block diagram also showing an internal configuration of the projector 5 according to the fifth embodiment. The difference in the internal configuration between the projector 5 and the projector 1 will be described with reference to FIG. 7.

The zoom amount storage unit 26 is formed of a non-volatile memory and stores the smallest and largest amounts of zooming representing the zooming state created by the zoom drive unit 23. The zoom amount storage unit 26 further stores, as default values, the smallest and largest adjustable amounts of zooming that can be produced by the zoom mechanism 13a.

The zoom amount storage unit 26 further stores, as the initial amount of zooming, the amount of zooming that allows a first zoom operation period, which is the period during which the zoom drive unit 23 drives the zoom mechanism 13a to achieve the stored smallest amount of zooming, to coincide with a second zoom operation period, which is the period during which the zoom drive unit 23 drives the zoom mechanism 13a to achieve the stored largest amount of zooming. The initial amount of zooming corresponds to the initial zooming state of the projection lens 13. The zoom control unit 20a reads and updates the stored initial amount of zooming. When it is detected that the initial amount of zooming described above is changed, the initial amount of zooming may be updated immediately or when the projector 5 is powered off.

The projector 5 is set to have the initial zooming state when it is powered on. The processes carried out when the projector 5 is powered on are the same as those in the flowchart shown in FIG. 3 used in the description of the first embodiment. No illustration or description of the processes will therefore be made.

According to the fifth embodiment described above, the following advantage is provided:

1. The projector 5 is set to have the initial zooming state when it is powered on. The zooming state therefore transits from the initial zooming state to the optimum zooming state when the automatic zoom adjustment is made. That is, the zooming state starts from the initial zooming state, in which the first zoom operation period coincides with the second zoom operation period, and is changed to the optimum zooming state. As a result, the period required for the zoom adjustment can be reduced because the period required for the zoom adjustment is shorter than or equal to the first zoom operation period (=second zoom operation period) at the maximum.

### Sixth Embodiment

A sixth embodiment will be described below.

The configuration of a projector 6 according to the sixth embodiment is similar to that in the fifth embodiment but differs therefrom only in terms of the timing at which the zoom drive unit 23 is driven to set the zooming state to the initial zooming state. In the fifth embodiment, the zooming state is set to the initial zooming state when the projector 5 is powered on, whereas in the present embodiment, the zooming state is not set to the initial zooming state when the projector 6 is powered on but the zooming state is set to the initial zooming state when the projected 6 is powered off. The automatic zoom adjustment is made in the same manner as in the first embodiment.

The processes carried out when the projector 6 is powered off are the same as those in the flowchart shown in FIG. 6 used in the description of the second embodiment. No illustration or description of the processes will therefore be made.

According to the sixth embodiment described above, the following advantages are provided:

1. The projector 6 is set to have the initial zooming state when it is powered off. The zooming state therefore transits from the initial zooming state to the optimum zooming state when the automatic zoom adjustment is made. That is, the zooming state starts from the initial zooming state, in which the first zoom operation period coincides with the second zoom operation period, and is changed to the optimum zooming state. As a result, the period required for the zoom adjustment can be reduced because the period required for the zoom adjustment is shorter than or equal to the first zoom operation period (=second zoom operation period) at the maximum.

2. Since the projector 6 is set to have the initial zooming state when it is powered off, it is not necessary to set the zooming state to the initial zooming state next time when the projector 6 is powered on. The period required for an initial process carried out when the projector 6 is powered on can therefore be reduced.

### Seventh Embodiment

A seventh embodiment will be described below.

In the configuration of a projector 7 according to the seventh embodiment, the first zooming state storage unit 25 in the first embodiment is replaced with a third zooming state storage unit 27 and the zoom control unit 20a carries out different processes. The other components in the seventh embodiment are the same as those in the first embodiment. The automatic zoom adjustment is made in the same manner as in the first embodiment.

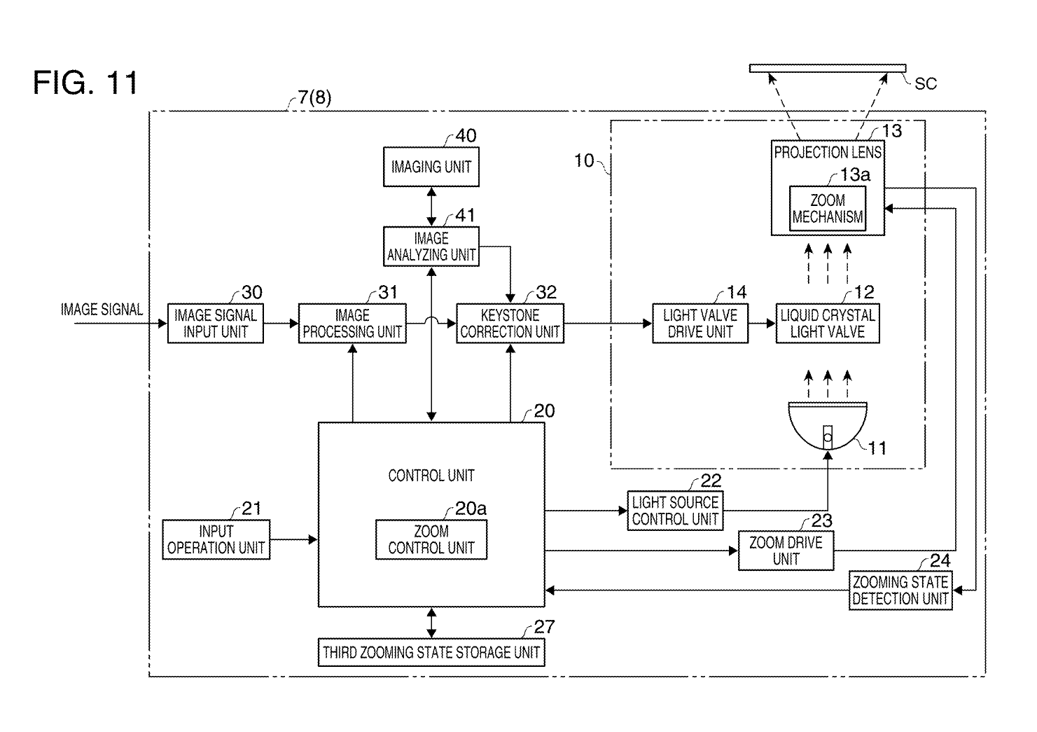

FIG. 11 is a block diagram showing an internal configuration of the projector 7 according to the seventh embodiment. The difference in the internal configuration between the projector 7 and the projector 1 will be described with reference to FIG. 11.

The third zooming state storage unit 27 is formed of a non-volatile memory and stores, as the initial amount of zooming, the amount of zooming representing the latest zooming state created by the zoom drive unit 23. The initial amount of zooming corresponds to the initial zooming state of the projection lens 13. The third zooming state storage unit 27 further stores, as a default value, the median value between the smallest and largest adjustable amounts of zooming that can be produced by the zoom mechanism 13a. The zoom control unit 20a reads and updates the stored initial amount of zooming. When it is detected that the initial amount of zooming described above is changed, the initial amount of zooming may be updated immediately or when the projector 7 is powered off.

The projector 7 is set to have the initial zooming state when it is powered on. The processes carried out when the projector 7 is powered on are the same as those in the flowchart shown in FIG. 3 used in the description of the first embodiment. No illustration or description of the processes will therefore be made.

According to the seventh embodiment described above, the following advantage is provided:

1. The projector 7 is set to have the initial zooming state when it is powered on. The zooming state therefore transits from the initial zooming state to the optimum zooming state when the automatic zoom adjustment is made. That is, the zooming state starts from the initial zooming state, in which the first zoom operation period coincides with the second zoom operation period, and is changed to the optimum zooming state. As a result, the period required for the zoom adjustment can be reduced because the period required for the zoom adjustment is shorter than or equal to the first zoom operation period (=second zoom operation period) at the maximum.

### Eighth Embodiment

An eighth embodiment will be described below.

The configuration of a projector 8 according to the eighth embodiment is similar to that in the seventh embodiment but differs therefrom only in terms of the timing at which the zoom drive unit 23 is driven to set the zooming state to the initial zooming state. In the seventh embodiment, the zooming state is set to the initial zooming state when the projector 7 is powered on, whereas in the present embodiment, the zooming state is not set to the initial zooming state when the projector 8 is powered on but the amount of zooming corresponding to the zooming state when the projector 8 is powered off is saved in the third zooming state storage unit 27 and the setting of the current zooming state is maintained. The automatic zoom adjustment is made in the same manner as in the first embodiment.

According to the eighth embodiment described above, the projector 8 is set to have the initial zooming state when it is powered off. In this way, since the projector has been already set to have the initial zooming state next time when the projector is used, the zoom adjustment period required to achieve the optimum zooming state can be reduced.

When the initial amount of zooming read from the third zooming state storage unit 27 is compared with the current zooming state when the projector 8 is powered on, and the initial amount of zooming does not coincide with the current zooming state, the zoom drive unit 23 may be driven so that the initial amount of zooming, that is, the third zooming state, is achieved, as in the seventh embodiment described above. The configuration described above allows the projection lens 13 to be set to the initial zooming state based on the initial amount of zooming read from the third zooming state storage unit 27 even when the zooming state of the projection lens 13 changes due to some reasons with the projector 8 powered off.

The invention is not limited to the embodiments described above, but a variety of changes and modifications can be made. Variations of the invention will be described below.

### Variation 1

In the first and second embodiment, the first zooming state corresponds to the median angle of projection field between the smallest angle of projection field and the largest angle of projection field. The first zooming state may alternatively correspond to an approximately median angle of projection field between the smallest angle of projection field and the largest angle of projection field. In this case as well, the same advantageous effect can be provided.

### Variation 2

In the third and fourth embodiments described above, the second zooming state is based on the median amount of zooming between the smallest actually produced past amount of zooming and the largest actually produced past amount of zooming. The second zooming state may alternatively be based on an approximately median amount of zooming between the smallest actually produced past amount of zooming and the largest actually produced past amount of zooming. In this case as well, the same advantageous effect can be provided.

### Variation 3

In the fifth to eighth embodiments described above, the initial zooming state is the zooming state in which the first zoom operation period coincides with the second zoom operation period. The initial zooming state may alternatively be a zooming state in which the first zoom operation period approximately coincides with the second zoom operation period. In this case as well, the same advantageous effect can be provided.

### Variation 4

In the first to eighth embodiments described above, after the projector is set to have a predetermined zooming state (first zooming state, second zooming state, or initial zooming state), the automatic zoom adjustment is made. Alternatively, the automatic zoom adjustment is not made, but manual zoom adjustment may be made by the user. When the zoom adjustment is made manually, the following parameters that will be changed in association with the zoom adjustment can also be reduced by using a predetermined zooming state as the start position: the amount of angular change in the angle of projection field, the travel produced in the zooming operation, and the period during which the zoom mechanism is operated.

### Variation 5

In the first to eighth embodiments described above, the buttons provided on the projector body are presented as the input operation unit 21, but the input operation unit 21 is not limited thereto. For example, the input operation unit 21 may alternatively be an IP network communication unit (not shown), an RS-232C communication unit (not shown), and a USB (Universal Serial Bus) communication unit (not shown) that send and receive operation signals and other signals to and from the projector.

### Variation 6

In the first to eighth embodiments described above, the transmissive liquid crystal light valve 12 is used as the light modulator. A reflective liquid crystal light valve or any other reflective light modulator can alternatively used. Still alternatively, the light modulator can be a micro-mirror array device or any other similar device in which the direction in which the incident light exits is controlled for each micro-mirror as a pixel to modulate the light emitted from a light source.

What is claimed is:

1. A projector comprising:
a projection lens including a zoom mechanism;
a zoom drive unit that drives the zoom mechanism;
a zoom amount storage unit that stores an amount of zooming produced when the zoom drive unit drives the zoom mechanism;
an operation signal receiving unit that receives a predetermined operation signal; and
a zoom control unit that controls the zoom drive unit so as to change a current zooming state to an initial zooming state when the operation signal receiving unit receives the predetermined operation signal, the initial zooming state is determined by the amount of zooming stored in the zoom amount storage unit.

2. The projector according to claim 1,
wherein the initial zooming state represents the median amount of zooming between the smallest amount of zooming and the largest amount of zooming stored in the zoom amount storage unit.

3. The projector according to claim 1,
wherein the initial zooming state represents the amount of zooming that allows a first zoom operation period during which the zoom drive unit is operated to achieve the smallest amount of zooming stored in the zoom amount storage unit to coincide with a second zoom operation period during which the zoom drive unit is operated to achieve the largest amount of zooming stored in the zoom amount storage unit.

4. The projector according to claim 1,
wherein the initial zooming state represents the last used amount of zooming stored in the zoom amount storage unit.

5. The projector according to claim 1,
wherein the predetermined operation signal received by the operation signal receiving unit is one of a power-on operation signal and a power-off operation signal.

6. A method for controlling a projector including a projection lens including a zoom mechanism, a zoom drive unit that drives the zoom mechanism, and a zoom amount storage unit that stores an amount of zooming produced when the zoom drive unit drives the zoom mechanism, the method comprising:
receiving a predetermined operation signal; and
controlling the zoom drive unit so as to change a current zooming state to an initial zooming state when the predetermined operation signal is received, the initial zooming state is determined by the amount of zooming stored in the zoom amount storage unit.

7. The controlling method according to claim 6,
wherein the initial zooming state represents the median amount of zooming between the smallest amount of zooming and the largest amount of zooming stored in the zoom amount storage unit.

8. The controlling method according to claim 6,
wherein the initial zooming state represents the amount of zooming that allows a first zoom operation period during which the zoom drive unit is operated to achieve the smallest amount of zooming stored in the zoom amount storage unit to coincide with a second zoom operation period during which the zoom drive unit is operated to achieve the largest amount of zooming stored in the zoom amount storage unit.

9. The controlling method according to claim 6,
wherein the initial zooming state represents the last used amount of zooming stored in the zoom amount storage unit.

10. The controlling method according to claim 6,
wherein the predetermined operation signal received by the operation signal receiving unit is one of a power-on operation signal and a power-off operation signal.
